(19) United States
(12) Patent Application Publication
(10) Pub. No.: US 2023/0090423 A1
(43) Pub. Date: Mar. 23, 2023

(54) METHOD FOR WHOLE-PROCESS NUMERICAL SIMULATION AND HAZARD FORECAST OF MOUNTAIN DISASTER

(71) Applicant: Institute of Mountain Hazards and Environment, Chinese Academy of Sciences, Chengdu (CN)

(72) Inventors: Peng CUI, Chengdu (CN); Qiang ZOU, Chengdu (CN); Chaojun OUYANG, Chengdu (CN)

(73) Assignee: Institute of Mountain Hazards and Environment, Chinese Academy of Sciences, Chengdu (CN)

(21) Appl. No.: 17/897,261

(22) Filed: Aug. 29, 2022

(30) Foreign Application Priority Data
Sep. 18, 2021 (CN) 202111097564.8

(51) Int. Cl. G06F 30/28; G06F 17/11; G01W 1/10; G01W 1/14

(52) U.S. Cl. CPC G06F 30/28; G06F 17/11; G01W 1/10; G01W 1/14

(57) ABSTRACT

A method for a whole-process numerical simulation and hazard forecast of a mountain disaster is provided. The method includes: S1, a high space-time rainfall forecast of a mountain area; S2, a hydrodynamic process and numerical simulation: establishing a hydrodynamic process model and solving the hydrodynamic process model; S3, a motion model and numerical simulation of a mountain torrent and debris flow disaster; and S4, a risk analysis and hazard forecast of a small watershed disaster. The present invention predicts disaster hazard and dynamically and quantitatively evaluates risk loss according to a whole-process scenario simulation of the disaster driven by a climate forecast result, improves current disaster level forecasts to hazard forecasts, and serves for accurate disaster preventions and accurate rescues.

### CROSS REFERENCE TO THE RELATED APPLICATION

This application claims priority based on Chinese patent application 202111097564.8 filed on Sep. 18, 2021. The disclosure of the aforementioned application is hereby incorporated by reference in its entirety.

### TECHNICAL FIELD

The present invention relates to the technical field of a mountain disaster numerical forecast research, and in particular to a method for a whole-process numerical simulation and hazard forecast of a mountain disaster.

### BACKGROUND

Extreme weather and climate lead to frequent disasters in mountain areas, resulting in continuous increase of direct economic losses of disasters, and the intensification of climate changes makes the catastrophe risk show an increasing trend and difficult to predict, which are one of the major scientific and technological problems faced by current disaster prevention and reduction. In the prior art, there are mainly the following defects.

1. At present, the formation mechanism and evolution of typical single disasters are relatively mature. However, under extreme weather and climate conditions, the understanding of disaster formation mechanism and dynamic process mechanism under the influence of complex terrain and human activities in mountain areas still needs to be deepened.

At present, a large number of research at home and abroad focus on the formation mechanism and impact analysis of single disasters such as landslide, flood and debris flow in a specific environment. On this basis, a relatively perfect regional scale mountain single factor risk assessment method has been established. The mountain area has an active geological structure, wide topographic height difference, strong water vapor exchange and obvious climate spatial differentiation. The active neotectonic motion makes the geological environment in the mountain area extremely fragile, which provides sufficient material conditions for the formation of mountain torrents and debris flows; and the terrain having high drop and large slope provides huge energy conditions for disaster development, such that mountain torrents and debris flows often break out in the form of large-scale and high-speed motion. Moreover, the short-term prediction of extreme climate at home and abroad has just started, and there is a lack of mature theory and effective technology. There is a lack of systematic research on the law and mechanism of extreme climate variation in mountain areas, resulting in low accuracy of short-term climate prediction; and there is a lack of insufficient understanding of the formation mechanism of rainstorm and the complex terrain and underlying surface characteristics, resulting in the significantly low prediction level of extreme rainstorm events in mountain areas. Therefore, considering the disaster-causing mechanism and dynamic process mechanism in mountain complex environments under extreme weather and rainstorm conditions is a hot and difficult issue that has taken an interest in the current international academic circles. On one hand, it is necessary to determine the response law of regional mountain hydrological, ecological, geotechnical and other environmental conditions to climate changes, and determine the hydrological process of mountain small watersheds under the action of extreme weather and climate; and on the other hand, it is necessary to solve the problem of the complex coupling mechanism of geotechnical-hydrological-ecology, the evolution process of disaster motion and quantitative prediction of hazard under the excitation of local rainfall in small watersheds, scientifically understand the dynamic interaction mechanism between disasters and disaster-bearing bodies, and break through the problem of quantitative evaluation of physical vulnerability of disaster-bearing bodies. Therefore, it is necessary to deeply carry out research on the disaster-causing process and mechanism of multi-factor coupling of mountain hydrology, ecology, rock and soil, and clarify the temporal and spatial variation law of critical rainfall conditions of mountain torrent and debris flow disasters under different starting modes, so as to provide a theoretical basis for disaster numerical forecast and risk assessment of small mountain watersheds on the basis of dynamics.

2. The lack of physical models and computation platforms for describing the whole process of disaster starting-motion-accumulation in small mountain watersheds limits the quantitative risk assessment and numerical forecast of disasters in small mountain watersheds.

The mountain area has large vertical drop, complex terrain and landform, which is controlled by the complex environmental conditions of the mountain underlying surface. The disaster starting-motion-accumulation and disaster formation process of small mountain watersheds involves complex water-soil-biological coupling process. It is the basis for establishing the quantitative assessment of disaster risks to construct an appropriate mathematical and physical model to describe the dynamic process of the small mountain watershed. At present, scholars at home and abroad have gradually developed from qualitative assessment based statistics to quantitative assessment based dynamic evolution in the hazard assessment of mountain disasters in the small mountain watershed; and vulnerability assessment has gradually developed from qualitative assessment based on social, economic, population and other economic indicators to physical vulnerability assessment based on structural damage of the disaster-bearing body. In the field of dynamic models and numerical methods, many well-known international research teams have developed computation programs and solution methods based on long-term research and algorithm models, and have carried out numerical simulation research on disaster dynamic process and evolution based on dynamics, so as to promote the ability of mountain disaster motion simulation, and for example, FLO-2D software in the United States, RAMMS software in Switzerland, Massove 2D software in Austria, Massflow in China, etc. can better simulate and reproduce the disasters that have occurred. To a certain extent, these simulation methods and computation programs have invert the debris flow scenario that has occurred, but cannot really simulate (forward) the motion process of mountain disasters. The main bottleneck restricting the effective advanced prediction and evaluation of disaster dynamic process and risk in the numerical simulation of geological disasters based on a dynamic process lies in the selection of appropriate physical models, the determination of physical and mechanical parameters, and how to adapt to complex topographic and geomorphic conditions, mountain rainfall forecast, water and soil coupling and gully bed erosion in numerical computation.

Therefore, in combination with the fine weather forecast system of small mountain watersheds, the confluence process, which is generated under rainfall conditions, of complex small mountain watersheds is utilized to construct a physical model of the whole process of mountain disaster starting-motion-disaster causing, and establish a method for numerical simulation and quantitative risk assessment of a dynamic evolution process in a whole process of mountain torrent and debris flow disasters in small mountain watersheds, so as to achieve quantitative description and risk assessment of disaster dynamic evolution, and provide key technical and scientific support for disaster reduction and prevention in small mountain watersheds, so as to ensure the development safety of mountain areas and the construction of beautiful China.

3. The mountain single factor risk assessment method is relatively mature, but lacks comprehensive research on the disaster-causing mechanism of water-soil-biological coupling process, which restricts the technical breakthrough of comprehensive risk understanding and quantitative assessment, and it is urgent to carry out quantitative assessment and mapping research of mountain risks under cross-scale multi-factor coupling.

At present, a large number of researches at home and abroad focus on the impact of climate changes on mountain ecology, hydrology and disasters, and the relatively perfect regional scale mountain single factor risk assessment method has been established. In the aspect of mountain single factor hazard assessment, scholars at home and abroad have gradually developed from qualitative assessment based on statistics to quantitative assessment based on dynamic evolution; and vulnerability assessment has gradually developed from qualitative assessment based on social, economic, population and other economic indicators to physical vulnerability assessment based on structural damage of the disaster-bearing body. The mountain ecosystem, water cycle process and disaster process show the dynamic process of sudden and intermittent coexistence under climate changes. There is few research on the micro mechanism and the disaster-causing influence of mountain ecological-hydrological-geotechnical process. Most of the mountain risk assessment index systems are background environmental factors such as terrain, geology, soil and multi-year rainfall. The existing mountain risk assessment index can only reflect a long-term steady-state and static index, and cannot reflect the development trend and change process of mountain risks under climate changes, thereby seriously restricting the theoretical and technological breakthrough of mountain risk understanding and quantitative assessment. Quantitative assessment of the mountain risk is a hot and difficult issue that has taken an interest in international academic circles. On the one hand, it is necessary to determine the response law of regional mountain hydrological, ecological, geotechnical and other environmental conditions to climate changes, and determine the imbalance conditions between the mountain ecological function and the hydrological system under the action of extreme climate; and on the other hand, it is necessary to solve the problems of the complex coupling mechanism of geotechnical-hydrological-ecology, the evolution process of disaster motion and quantitative prediction of hazards under the excitation of local rainfall in small watersheds, scientifically understand the dynamic interaction mechanism between the disaster and the disaster-bearing body, and break through the problem of quantitative assessment of physical vulnerability of the disaster-bearing body. Therefore, it is necessary to deeply carry out research on the disaster-causing process and mechanism of multi-factor coupling of mountain hydrology, ecology, rock and soil, and establish mountain risk comprehensive assessment models and hazard forecast technical methods at different time-space scales, so as to provide key scientific data and decision basis for green regulation of the mountain risk.

### SUMMARY

Aiming at the defects in the prior art, the present invention provides a method for whole-process numerical simulation and hazard forecast of a mountain disaster.

The specific technical solution of the present invention is as follows:

a method for whole-process numerical simulation and hazard forecast of a mountain disaster includes:

S1, high space-time rainfall forecast of a mountain area: interpolating forecast data having a space resolution of 9 KM to 0.01°*0.01° by means of a bilinear interpolation method, and establishing an empirical relation between a physical quantity and an elevation according to terrain to describe an influence of the terrain on precipitation;

S2, hydrodynamic process and numerical simulation: establishing a hydrodynamic process model, and solving the hydrodynamic process model;

S3: motion model and numerical simulation of a mountain torrent and debris flow disaster, where a depth-averaged continuous medium equation for facies averaging rainfall-induced debris flow is expressed as:

$$\frac{\partial h}{\partial t} + \frac{\partial hu}{\partial x} + \frac{\partial hv}{\partial y} = R - I + \frac{E}{1 - p}$$

$$\frac{\partial hu}{\partial t} + \frac{\partial ( {hu}^{2} + 0.5 {gh}^{2} )}{\partial x} + \frac{\partial huv}{\partial y} = - gh \frac{\partial {z}_{b}}{\partial x} - \frac{{τ}_{fx}}{ρ} - \frac{( {ρ}_{s} - {ρ}_{f} ) {gh}^{2}}{2 ρ} \frac{\partial c}{\partial x} + \frac{( {ρ}_{b} - ρ ) uE}{ρ ( 1 - p )}$$

$$\frac{\partial hv}{\partial t} + \frac{\partial huv}{\partial x} + \frac{\partial ( {hv}^{2} + 0.5 {gh}^{2} )}{\partial y} = - gh \frac{\partial {z}_{b}}{\partial y} - \frac{{τ}_{fy}}{ρ} - \frac{( {ρ}_{s} - {ρ}_{f} ) {gh}^{2}}{2 ρ} \frac{\partial c}{\partial y} + \frac{( {ρ}_{b} - ρ ) vE}{ρ ( 1 - p )}$$

$$\frac{\partial hc}{\partial t} + \frac{\partial huc}{\partial x} + \frac{\partial hvc}{\partial y} = E$$

$$\frac{\partial {z}_{b}}{\partial t} = - \frac{E}{1 - p}$$

where t represents time, x and y are horizontal coordinates, h represents a fluid depth, u and v are speed components of a fluid depth-averaged speed in an x direction and a y direction, respectively, c is a depth-averaged solid phase concentration, g is gravitational acceleration, R is reduced rainfall intensity after vegetation interception, I is an infiltration rate, Z_{b} is a substrate elevation, ρ is the density of a solid-liquid mixture, ρ=cρ, +(1−c) ρⱼ, ρₛ and ρ_{f} are concentrations of a solid phase and a liquid phase respectively, ρ_{b} is the density of a saturated substrate, ρ_{b}=(1−p) ρₛ+pρ_{f}, p is the porosity of a substrate material, τ_{fx} and τ_{fy} are substrate resistances in the x direction and the y direction respectively, and E is an erosion rate of the substrate; and

S4: risk analysis and hazard forecast of a small watershed disaster:

computing a comprehensive disaster-causing risk degree of the disaster: determining the comprehensive disaster-causing risk degree of the disaster according to composite hazard characteristics of impact and burying of the mountain disaster;

analyzing vulnerability: computing vulnerability of disaster-bearing bodies according to values of the disaster-bearing bodies and vulnerability indexes of the disaster-bearing bodies; and

computing a risk degree of the disaster: determining the risk of the disaster on the basis of a numerical simulation result, where the risk of the disaster is a comprehensive function of a comprehensive hazard of the disaster, the vulnerability of the disaster-bearing bodies and exposure of the disaster-bearing bodies.

Further, in step S1, the bilinear interpolation method includes:

computing an attribute value at a point P=(x, [symbol] ), carrying out linear interpolation in the x direction to obtain

$$f ( {R}_{1} ) \approx \frac{{x}_{2} - x}{{x}_{2} - {x}_{1}} f ( {Q}_{11} ) + \frac{x - {x}_{1}}{{x}_{2} - {x}_{1}} f ( {Q}_{21} ) ,$$

where R₂=(x, [symbol] ₁), and

$$f ( {R}_{2} ) \approx \frac{{x}_{2} - x}{{x}_{2} - {x}_{1}} f ( {Q}_{12} ) + \frac{x - {x}_{1}}{{x}_{2} - {x}_{1}} f ( {Q}_{22} ) ,$$

where R₂=(x, [symbol] ₂), and

then carrying out linear interpolation in the y direction to obtain

$$f ( P ) \approx \frac{{2}_{} -}{{2}_{} - {1}_{}} f ( {R}_{1} ) + \frac{- {1}_{}}{{2}_{} - {1}_{}} f ( {R}_{2} )$$

so as to further obtain a desired result f(x, [symbol] ):

$$f ( x , ) \approx \frac{f ( {Q}_{11} )}{( {x}_{2} - {x}_{1} ) ( {2}_{} - {1}_{} )} ( {x}_{2} - x ) ( {2}_{} - ) + \frac{f ( {Q}_{21} )}{( {x}_{2} - {x}_{1} ) ( {2}_{} - {1}_{} )} ( x - {x}_{1} ) ( {2}_{} - ) + \frac{f ( {Q}_{12} )}{( {x}_{2} - {x}_{1} ) ( {2}_{} - {1}_{} )} ( {x}_{2} - x ) ( - {1}_{} ) + \frac{f ( {Q}_{22} )}{( {x}_{2} - {x}_{1} ) ( {2}_{} - {1}_{} )} ( x - {x}_{1} ) ( - {1}_{} )$$

where f represents a corresponding attribute value at a certain point, and Q₁₁, Q₁₂, Q₂₁ and Q₂₂ represent point positions at (x₁, y₁), (x₁, y₂), (x₂, y₁) and (x₂, y₂).

Further, in step S2, the establishing a hydrodynamic process model includes:

carrying out deep integral simplification on the basis of a Navier-Stokes equation and ignoring convection terms in a momentum equation to obtain a diffusion wave model, quantitatively computing a hydrodynamic process of a small watershed, introducing the Aston vegetation rainfall interception model and a Green-Ampt slope saturation infiltration model on the basis of the diffusion wave model to establish the hydrodynamic process model, and simulating a whole physical event from rainfall to vegetation interception and slope infiltration and then to runoff generation and motion.

Further, a governing equation for the hydrodynamic process model is:

$$\frac{\partial h}{\partial t} + \frac{\partial hu}{\partial x} + \frac{\partial hv}{\partial y} = R - V - I$$

$$\frac{\partial ( 1 / 2 {gh}^{2} )}{\partial x} = - gh \frac{\partial {z}_{b}}{\partial x} + {S}_{fx}$$

$$\frac{\partial ( 1 / 2 {gh}^{2} )}{\partial y} = - gh \frac{\partial {z}_{b}}{\partial y} + {S}_{fy}$$

where t is time, x and y are the horizontal coordinates, h represents the fluid depth, u and v represent the speed components of the fluid depth-averaged speed in the x direction and the y direction respectively, R is the reduced rainfall intensity after vegetation interception, I is the infiltration rate, V is vegetation interception, g is the gravitational acceleration, Z_{b} is the substrate elevation S_{fx} and S_{fy} represent substrate friction terms in the x direction and the y direction respectively, and S_{fx} and S_{fy} are expressed by Manning models as:

$${S}_{fx} = g \frac{{n}^{2} u \sqrt{{u}^{2} + {v}^{2}}}{{h}^{1 / 3}}$$

$${S}_{fy} = g \frac{{n}^{2} v \sqrt{{u}^{2} + {v}^{2}}}{{h}^{1 / 3}}$$

where n is a Manning coefficient, h represents the fluid depth, u and v represent the speed components of the fluid depth-averaged speed in the x direction and the y direction respectively, and g is the gravitational acceleration;

an Aston vegetation rainfall interception model used by vegetation interception V is expressed as:

$$V = S ( 1 - {e}^{- k \frac{{P}_{c}}{{S}_{max}}} )$$

where Sₘₐₓ is maximum interception of vegetation, and according to computation of different types of vegetation, P_{c} is accumulated rainfall, and k is a parameter related to the canopy density of the vegetation, and is expressed as:

k=1−e^{-(Co*LAI)}

where Co is the canopy density of the vegetation, and is a leaf area index; and

the infiltration rate I is expressed by a slope saturation infiltration model as:

$$I = \frac{df}{dt} = {k}_{s} [ ( {ψ}_{f} + h ) \frac{{θ}_{s} - {θ}_{i}}{f} + 1 ]$$

where t is time, kₛ is a saturated hydraulic coefficient, ψ_{f} is a matrix suction water head at a front end of a wetting front, θₛ is saturated moisture content of soil, θₜ is initial moisture content of the soil, and f is an accumulated infiltration depth.

Further, in step S2, the solving the hydrodynamic process model includes:

carrying out numerical solution by means of a first-order windward difference scheme to carry out fine-grained parallelization on a program.

Further, in step S4, the comprehensive disaster-causing risk degree of the disaster is computed by the following model:

$$H = {H}_{e} + {H}_{d}$$

$${H}_{d} = \frac{{N}_{i , j} Δ V}{A}$$

$${H}_{e} = A \cdot {max}_{t > 0} [ ( {u}^{2} + {v}^{2} ) h ρ ]$$

where H is the comprehensive disaster-causing risk degree of the disaster, and Hₑ is a hazard caused by impact damage and is expressed by maximum kinetic energy of a disaster-causing body; H_{d} is a hazard caused by burying and is expressed by a maximum burying depth of the disaster-causing body; N_{i,j} is equal to the number of particles in a control grid centered on (i,j); ΔV is a volume of the particle; A is a grid area; and u and v represent the speed components of the fluid depth-averaged speed in the x direction and the y direction respectively, h is the fluid depth, and is the density of the solid-liquid mixture.

Further, in step S4, analyzing vulnerability: computing vulnerability of disaster-bearing bodies according to values of the disaster-bearing bodies and vulnerability indexes of the disaster-bearing bodies includes:

describing vulnerability of the i^{th} type of disaster-bearing bodies as:

Vᵢ=V(u)ᵢ×Cᵢ

where Vᵢ is the vulnerability of the ith type of disaster-bearing bodies, V(u) is a comprehensive value of the ith type of disaster-bearing bodies, and is a vulnerability index of the ith type of disaster-bearing bodies,

where quantification of the comprehensive value V(u) of the disaster-bearing bodies depends on an average unit price Dₑ of the disaster-bearing bodies and an actual area Aₑ affected by the disaster, which is expressed as: and

V(u)=Dₑ×Aₑ

the vulnerability index C of the disaster-bearing bodies is expressed as:

$$C = \frac{h}{{H}_{c}}$$

where his the fluid depth, H_{C} is a geometric height of the disaster-bearing bodies, and C is valued as 1 when

$$\frac{h}{{H}_{c}} \geq 1.$$

Further, in step S4, the risk degree of the disaster is computed according to the following equation:

$$R = f ( H , {V}_{d} , {E}_{d} ) = {\sum }_{i = 1}^{n} {H}_{i} \times {V}_{i} \times {E}_{i}$$

where R is the risk degree of the disaster and is expressed by a certain numerical value ranging from 0 to 1; H is a comprehensive disaster-causing risk degree of the disaster, V_{d} is vulnerability of the disaster-bearing bodies, E_{d} is an exposure degree of the disaster-bearing body, Hᵢ is a comprehensive disaster-causing risk degree of the i^{th} type of disasters and is expressed by a certain numerical value ranging from 0 to 1; Vᵢ is a vulnerability degree of the i^{th} type of disaster-bearing bodies and is determined by damage degrees and values or the number of the disaster-bearing bodies; and Eᵢ is an exposure degree of the i^{th} type of disaster-bearing bodies, and is expressed by one of numerical values ranging from 0 to 1.

The beneficial effects lie in that

the present invention abuts a climate-weather prediction result considering climate changes and terrain effects in real time by means of research on theories and technical methods of a high space-time rainfall forecast method for a mountain area, hydrodynamic process and numerical simulation, slope material starting model and simulation, a mountain torrent and debris flow disaster motion model and numerical simulation, disaster risk analysis and hazard forecast of a small watershed, etc., predicts disaster hazard and dynamically and quantitatively evaluates risk loss according to whole-process scenario simulation of the disaster driven by a climate forecast result, improves current disaster level forecast to hazard forecast, and serves for accurate disaster prevention and accurate rescue.

### BRIEF DESCRIPTION OF DRAWINGS

In order to more clearly illustrate the specific implementations of the present invention or the technical solutions in the prior art, a brief introduction to the accompanying drawings required for the description of the specific implementations or the prior art will be provided below. Like elements or parts are generally identified by like reference numerals in all the drawings. In the drawings, elements or parts are not necessarily drawn to actual scale.

FIG. 1 is a flow chart of a high-resolution data processing technology in the present invention;

FIG. 2 is a schematic diagram of bilinear interpolation in the present invention;

FIG. 3 is a technical route diagram of a hydrodynamic module in the present invention;

FIG. 4 is a topographic map of a research area in the present invention;

FIG. 5 is a land utilization type map in the present invention;

FIG. 6 is a flow process graph in the present invention;

FIG. 7 is a map of a water depth simulation result of a Longxi river in the present invention;

FIG. 8 is a vulnerability grading map of a Longxi river watershed; and

FIG. 9 is a map of a risk grading result of a mountain disaster in the Longxi river watershed.

### DETAILED DESCRIPTION OF EMBODIMENTS

The technical solutions in the embodiments of the present invention are clearly and completely described below. Apparently, the embodiments described are merely some rather than all of the embodiments of the present invention. On the basis of the embodiments in the present invention, all other embodiments acquired by those of ordinary skill in the art without making creative efforts fall within the scope of protection of the present invention.

It should be noted that in all directional indications (such as top, bottom, left, right, front, rear . . . ) in the embodiments of the present invention are only used for explaining a relative position relation, motion, etc. between components under a certain specific attitude (as shown in the figures), and if the specific attitude is changed, the directional indications will be changed accordingly.

In addition, descriptions of “first,” “second”, etc. involved in the present invention are merely used for descriptive purposes and are not to be construed as indicating or implying their relative importance or implicitly specifying the number of indicated technical features. Thus, a feature defined with “first” and “second” may explicitly or implicitly include at least one of the features. In the description of the present invention, “plurality” means at least two, for example, two, three, etc. unless expressly specified otherwise.

For making the objectives, technical solutions and advantages of the present invention clearer, the present invention will be further described in detail below in conjunction with the drawings and embodiments. It should be understood that the particular embodiments described herein are merely used for explaining the present invention, and are not used for limiting the present invention.

The present invention is further described now with reference to the drawings of the description.

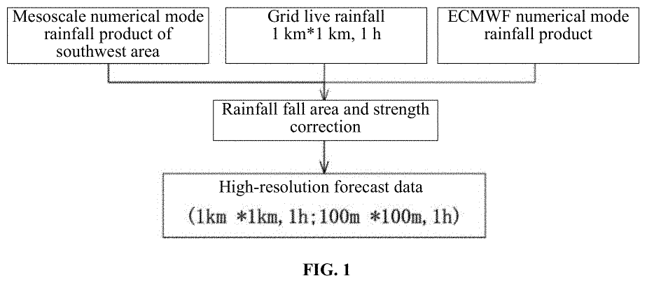

Embodiments of the present invention relate to explanation of a method for whole-process numerical simulation and hazard forecast of a mountain disaster. As shown in FIG. 1, the method specifically includes:

1. High Space-Time Rainfall Forecast of a Mountain Area

A precipitation forecast result is comprehensively determined on the basis of computation results of two modes: a global mode (which belongs to a regional rainfall forecast mode having forecast accuracy of 0.125°) of a European center and a mesoscale mode (which belongs to a kilometer-level rainfall dynamic forecast mode) of a southwest area. Firstly, a correction area is determined on the basis of a strong precipitation falling area of the European center, and moreover, a mode computation result of the southwest area is corrected in combination with two pieces of mode forecast data in a delimited precipitation area, so as to improve accuracy. In order to meet the requirement of meteorological data fining required for driving a mountain disaster model, spatial interpolation continue being carried out on a forecast result on the basis of correction, so as to improve space resolution of the data. In order to give consideration to timeliness and objectivity at the same time, a bilinear interpolation method (linear relations are established in longitude and latitude directions respectively, and physical quantity sizes on certain longitudes and latitudes are converted according to the relations) is used for interpolating forecast data having space resolution of 9 KM to 0.01°*0.01° (about 1 km), and then an empirical relation between a physical quantity and an elevation is established according to terrain, so as to describe an influence of the terrain on precipitation.

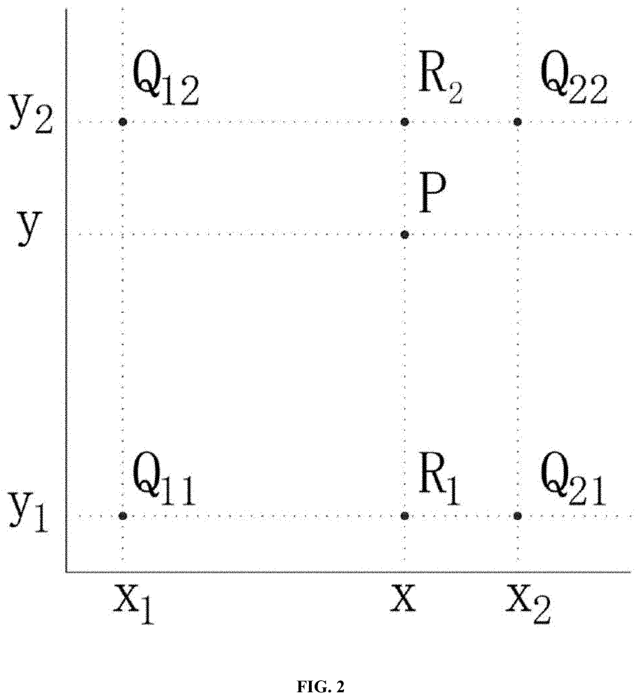

The interpolation method uses the bilinear interpolation method, which is also called as bilinear interpolation. The bilinear interpolation is linear interpolation expansion of an interpolation function having two variables, the core idea of which is that one-time linear interpolation is carried out respectively in two directions. An attribute value (FIG. 2) at a point P=(x,y) is computed, linear interpolation is carried out in an x direction to obtain

$$f ( {R}_{1} ) \approx \frac{{x}_{2} - x}{{x}_{2} - {x}_{1}} f ( {Q}_{11} ) + \frac{x - {x}_{1}}{{x}_{2} - {x}_{1}} f ( {Q}_{21} ) , where$$

$${R}_{1} = ( x , {y}_{1} ) , and$$

$$f ( {R}_{2} ) \approx \frac{{x}_{2} - x}{{x}_{2} - {x}_{1}} f ( {Q}_{12} ) + \frac{x - {x}_{1}}{{x}_{2} - {x}_{1}} f ( {Q}_{22} ) , where$$

$${R}_{2} = ( x , {y}_{2} ) , and$$

then linear interpolation is carried out in a y direction to obtain

$$f ( P ) \approx \frac{{2}_{} -}{{2}_{} - {1}_{}} f ( {R}_{1} ) + \frac{- {1}_{}}{{2}_{} - {1}_{}} f ( {R}_{2} )$$

so as to obtain a desired result f(x, [symbol] ):

$$f ( x , ) \approx \frac{f ( {Q}_{11} )}{( {x}_{2} - {x}_{1} ) ( {2}_{} - {1}_{} )} ( {x}_{2} - x ) ( {2}_{} - ) + \frac{f ( {Q}_{21} )}{( {x}_{2} - {x}_{1} ) ( {2}_{} - {1}_{} )} ( x - {x}_{1} ) ( {2}_{} - ) + \frac{f ( {Q}_{12} )}{( {x}_{2} - {x}_{1} ) ( {2}_{} - {1}_{} )} ( {x}_{2} - x ) ( - {1}_{} ) + \frac{f ( {Q}_{22} )}{( {x}_{2} - {x}_{1} ) ( {2}_{} - {1}_{} )} ( x - {x}_{1} ) ( - {1}_{} )$$

With reference to FIG. 2, a point P is obtained by data points Q11, Q12, Q22, Q23 and R1 and R2 to be interpolated.

In the equation, represents a corresponding attribute value at a certain point, and Q₁₁, Q₁₂, Q₂₁ and Q₂₂ represent point positions at (x₁, y₁), (x₁, y₂), (x₂, y₁) and (x₂, y₂).

2. Hydrodynamic Process and Numerical Simulation

### (1) Hydrodynamic Process Model

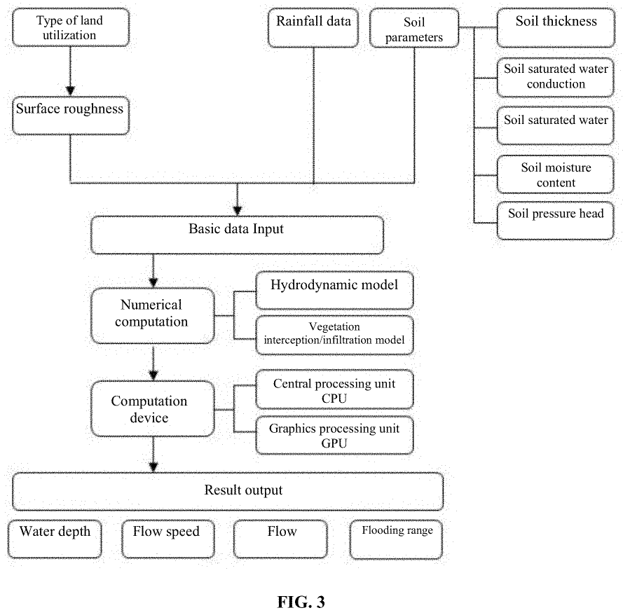

As shown in FIG. 3, a hydrodynamic module technical route diagram is shown. Depth integral simplification is carried out on the basis of a Naviers-Stokes equation and a convection term in a momentum equation is ignored to obtain a diffusion wave model, and a small watershed hydrodynamic process is quantitatively computed. An Aston vegetation rainfall interception model and a Green-Ampt slope saturation infiltration model are introduced on the basis of the diffusion wave model, and a whole physical event from rainfall to vegetation interception and slope infiltration, and then to runoff generation and motion is simulated, where a governing equation of the model is:

$$\frac{\partial h}{\partial t} + \frac{\partial hu}{\partial x} + \frac{\partial hv}{\partial y} = R - V - I$$

$$\frac{\partial ( 1 / 2 {gh}^{2} )}{\partial x} = - gh \frac{\partial {z}_{b}}{\partial x} + {S}_{fx}$$

$$\frac{\partial ( 1 / 2 {gh}^{2} )}{\partial y} = - gh \frac{\partial {z}_{b}}{\partial y} + {S}_{fy}$$

where t is time, x and y are horizontal coordinates, h represents a fluid depth, u and v represent speed components of a fluid depth-averaged speed in the x direction and the y direction respectively, R is reduced rainfall intensity after vegetation interception, I is an infiltration rate, V is vegetation interception, g is gravitational acceleration, Z_{b} is a substrate elevation, S_{fx} and S_{fy} represent substrate friction terms in the x direction and the y direction respectively, and

S_{fx} and S_{fy} are expressed by Manning models as:

$${S}_{fx} = g \frac{{n}^{2} u \sqrt{{u}^{2} + {v}^{2}}}{{h}^{1 / 3}}$$

$${S}_{fy} = g \frac{{n}^{2} v \sqrt{{u}^{2} + {v}^{2}}}{{h}^{1 / 3}}$$

where n is a Manning coefficient, h represents the fluid depth, u and v represent the speed components of the fluid depth-averaged speed in the x direction and the y direction respectively, and g is the gravitational acceleration.

The Aston vegetation rainfall interception model used by vegetation interception V is expressed as:

$$V = {S}_{max} ( 1 - {e}^{- k \frac{{P}_{c}}{{S}_{max}}} )$$

where Sₘₐₓ is maximum interception of vegetation, and according to computation of different types of vegetation, P_{c} is accumulated rainfall, and k is a parameter related to the canopy density of the vegetation, and is expressed as:

k=1−e^{-(Co*LAI)}

where Co is the canopy density of the vegetation, and is a leaf area index.

The infiltration rate I is expressed by the slope saturation infiltration model as:

$$I = \frac{df}{dt} = {k}_{s} [ ( {ψ}_{f} + h ) \frac{{θ}_{s} - {θ}_{i}}{f} + 1 ]$$

where t is time, kₛ is a saturated hydraulic coefficient, ψ_{f} is a matrix suction water head at a front end of a wetting front, θₛ is saturated moisture content of soil, is initial moisture content of the soil, and f is an accumulated infiltration depth.

### (2) Model Solving

For solving of a two-dimensional diffuse wave equation, in order to simulate a disaster physical process and ensure accuracy, stability and high efficiency of the model and a solution format, numerical solution is carried out by means of a first-order windward difference scheme, and fine-grained parallelization is carried out on a program by utilizing a graphics processing unit (GPU) (graphics card) computation device. There are two main architecture types (NVIDIA and AMD) of the graphics card currently used for high performance computation on the market. Generally, in the same level, the NVIDIA architecture features higher main performance and is more widely applied in various industries earlier, but in recent years, the AMD architecture is also gradually stepped into a high-performance computation mainstream channel, and has strong development momentum. A GPU-like computation card (DCU) is developed on the basis of the AMD architecture in the Sea Light series in China. A system platform has already completed GPU device program schemes of the two mainstream architectures, and different computation devices all have excellent compatibility and computational efficiency for different computation platforms.

### (3) Actual Computation Case for Longxi River

A case research area is a located in a Longhuan river watershed in a northwest mountain area of the Dujiangyan City in Sichuan. The Longxi river is used as a first-level branch of a minjiang river watershed, starts from the Longchi hummock located at the north of the Longxi river, converges into a minjiang river water system from the Duanmu garden located at the south of the Longhua river, and has an overall length of 18.22 km, a watershed area of 79 km², and an overall water flow direction from north to south. The Longxi river has branches of Zhucao valley, Lengjin valley, Modao valley, Jianping valley, etc., and numerous valleys. In administrative division, the Longxi river belongs to the Longchi town, and is 17 km away from the Dujiangyan City, the town is bounded by Zipingpu town to the East, Wenchuan county to the west, Zipingpu reservoir to the South and Hongkou township to the north, and the total population is more than 3000. There is Duwen Expressway in the south of Longxi River watershed. Leave from the expressway and take a Longchi tourist route to the Longchi town, or go from an urban area, and transportation is convenient.

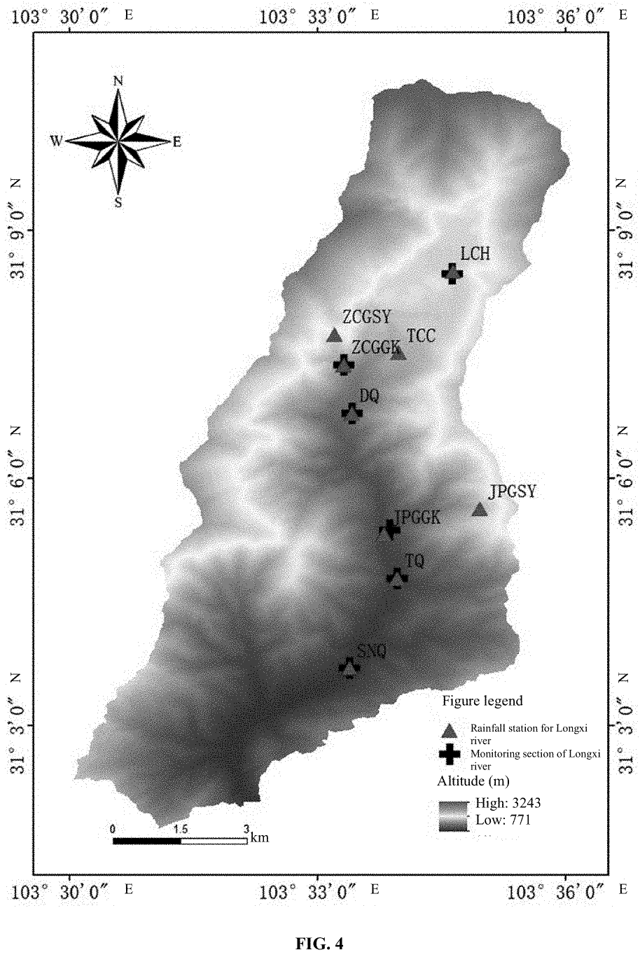

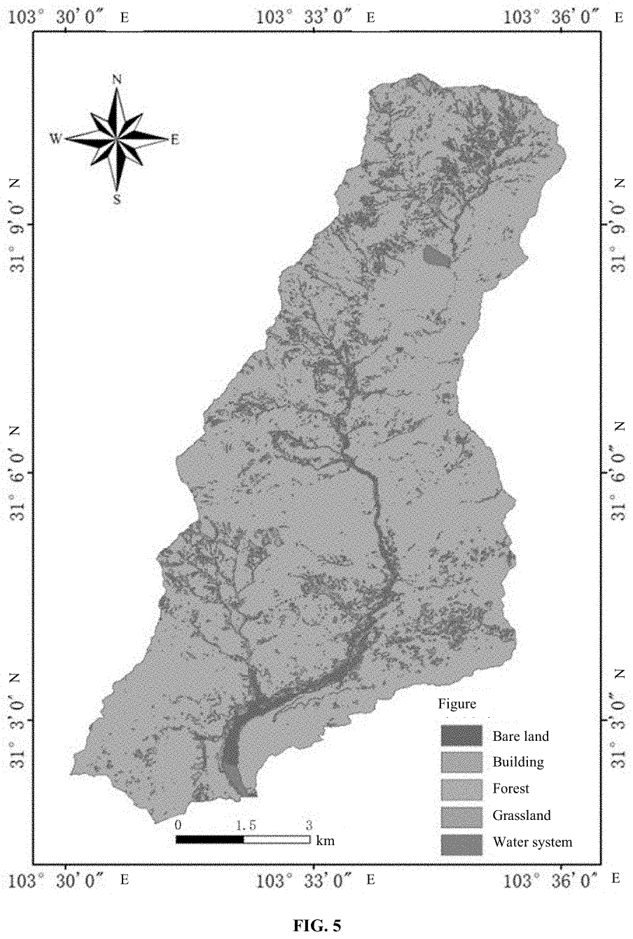

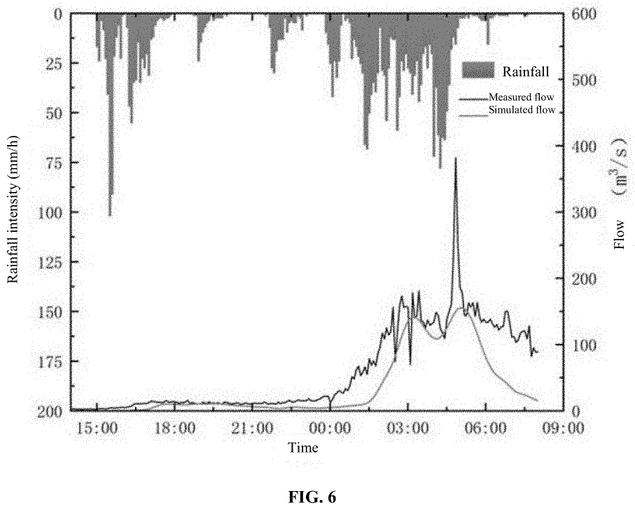

According to rainfall records collected from rainfall data of 9 rainfall stations in a research area from the early morning of June 24 to 23 p.m. of Jun. 26, 2018, and rainfall surface data are prepared by an inverse distance difference method. The rainfall stations and monitoring section positions are shown in FIGS. 4-6 below.

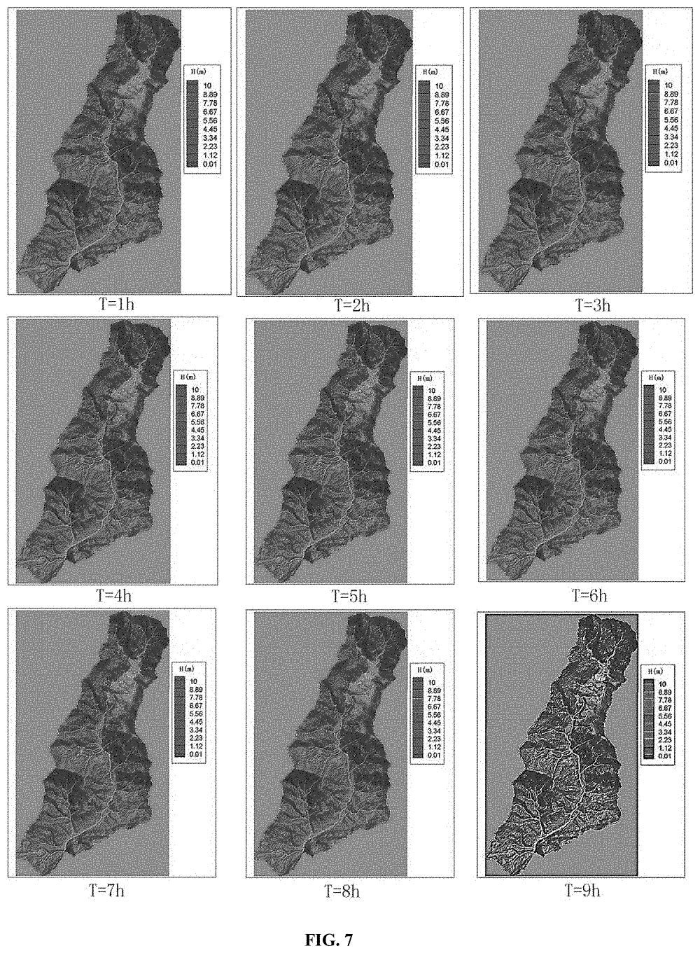

Due to long duration of rainfall, a total of 9 hours are selected from 20:00 on the 22nd to 5:00 on the 23rd. A simulated water depth result is shown in FIG. 7. By comparing with a measured flow process curve, a result shows that the hydrodynamic model of the system platform may reflect an overall trend of flood, and description of a mountain torrent process basically conforms to a measured result.

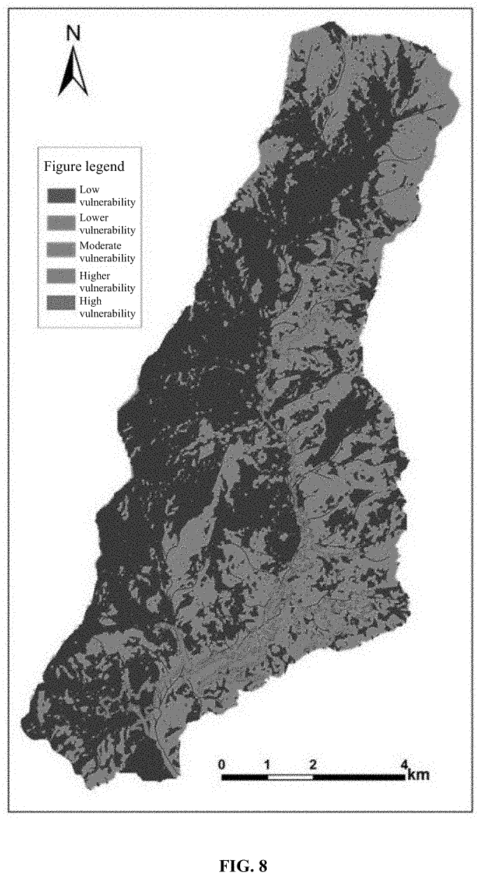

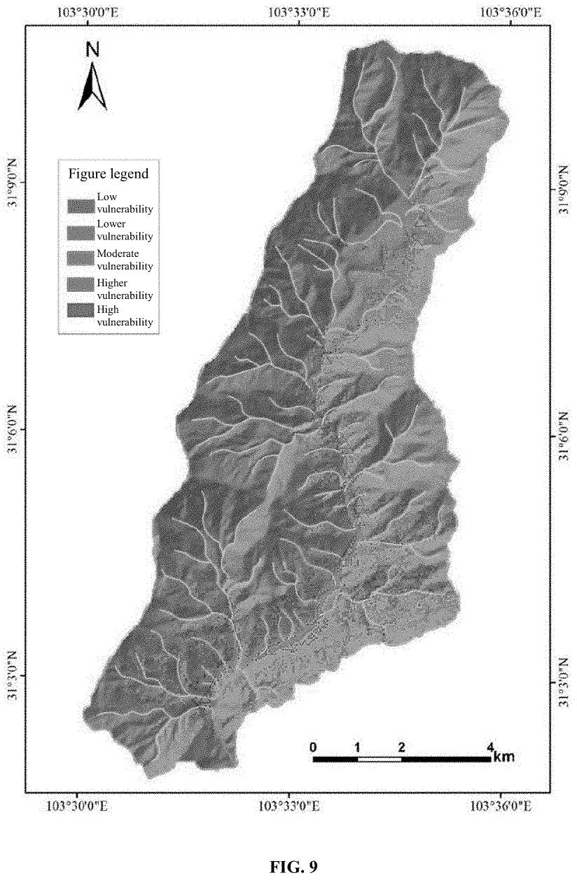

FIGS. 8 and 9 show a vulnerability grading map of a Longxi river watershed and a map of a risk grading result of a mountain disaster in the Longxi river watershed.

3. Motion Model and Numerical Simulation of a Mountain Torrent and Debris Flow Disaster

Due to the advantage of high computation efficiency, surface gravity flow such as flood, high-sand-content water flow and debris flow is usually solved by using a depth averaged shallow water wave equation, including a mass and momentum conservation equations in a motion process of the surface gravity flow. When an erosion or deposition process needs to be considered, an additional equation is needed to reflect a solid phase concentration and an equation for substrate erosion. A depth-averaged continuous medium equation for facies averaging a rainfall-induced debris flow is expressed as:

$$\frac{\partial h}{\partial t} + \frac{\partial hu}{\partial x} + \frac{\partial hv}{\partial y} = R - I + \frac{E}{1 - p}$$

$$\frac{\partial hu}{\partial t} + \frac{\partial ( {hu}^{2} + 0.5 {gh}^{2} )}{\partial x} + \frac{\partial huv}{\partial y} = - gh \frac{\partial {z}_{b}}{\partial x} - \frac{{τ}_{fx}}{ρ} - \frac{( {ρ}_{s} - {ρ}_{f} ) g {h}^{2}}{2 ρ} \frac{\partial c}{\partial x} + \frac{( {ρ}_{b} - ρ ) uE}{ρ ( 1 - p )}$$

$$\frac{\partial hv}{\partial t} + \frac{\partial huv}{\partial x} + \frac{\partial ( {hv}^{2} + 0.5 {gh}^{2} )}{\partial y} = - gh \frac{\partial {z}_{b}}{\partial y} - \frac{{τ}_{fy}}{ρ} - \frac{( {ρ}_{s} - {ρ}_{f} ) g {h}^{2}}{2 ρ} \frac{\partial c}{\partial y} + \frac{( {ρ}_{b} - ρ ) vE}{ρ ( 1 - p )}$$

$$\frac{\partial hc}{\partial t} + \frac{\partial huc}{\partial x} + \frac{\partial h v c}{\partial y} = E$$

$$\frac{\partial {z}_{b}}{\partial t} = - \frac{E}{1 - p}$$

where t represents time, x and y are horizontal coordinates, h represents a fluid depth, u and v are speed components of a fluid depth-averaged speed in an x direction and a y direction, respectively, c is a depth-averaged solid phase concentration, g is gravitational acceleration, R is reduced rainfall intensity after vegetation interception, I is an infiltration rate, Z_{b} is a substrate elevation, ρ is the density of a solid-liquid mixture, and ρ=cρₛ+(1−c)ρ_{f}, ρₛ and ρ_{f} are concentrations of a solid phase and a liquid phase respectively, ρ_{b} is the density of a saturated substrate, ρ_{b}=(1−p)ρₛ+pρ_{f}, p is the porosity of a substrate material, τ_{fx} and τ_{fy} are substrate resistances in the x direction and the y direction respectively, and E is an erosion rate of the substrate.

An equation of the erosion rate may be expressed as:

$$E = \frac{{τ}_{f} - {τ}_{r}}{ρ \sqrt{{u}^{2} + {v}^{2}}}$$

where shear stress τ_{f} of the solid-liquid mixture with the substrate may be expressed as a combination τf=cτ_{fs}÷(1−c)τ_{fw} of solid phase shear stress and liquid phase shear stress, c is a depth-averaged solid phase concentration, the solid phase shear stress is τⱼₛ=(ρₛ−ρ_{f}) gh tan ϕ_{bed} the liquid phase shear stress is τ_{fw}=ρ_{f}gn²(u²+v²)h^{-1/3}, ϕ_{bed} is a Coulomb friction angle of the substrate, n is a Manning coefficient, ρₛ and ρ_{f} are concentrations of the solid phase and the liquid phase respectively, h represents the fluid depth, u and v are speed components of the fluid depth-averaged speed along the x direction and y direction respectively, g is gravitational acceleration, the shear stress resistance of a substrate erosion layer may be expressed τᵣ=cₒ+(1−λ) ρgh tan ϕ_{bin}, cₒ and ϕ_{bin} are cohesion and an internal friction angle of the substrate material respectively, λ is a pore water pressure coefficient of the substrate, ρ is the density of the solid-liquid mixture, h represents the fluid depth, and g is gravitational acceleration.

4. Risk Analysis and Hazard Forecast of a Small Watershed Disaster

### (1) Comprehensive Hazard Assessment for the Disaster

The destructive power of mountain disasters depends on different disaster-causing modes of the disasters, such that hazard degrees of the disasters are different. Considering composite hazard characteristics of impact and burying of mountain disasters, a comprehensive disaster-causing risk degree of the disasters is determined, and a computation model is as follows:

$$H = {H}_{e} + {H}_{d}$$

$${H}_{d} = \frac{{N}_{i , j} Δ V}{A}$$

$${H}_{e} = A \cdot {max}_{t > 0} [ ( {u}^{2} + {v}^{2} ) h ρ ]$$

where H is the comprehensive disaster-causing risk degree of the disaster, Hₑ is a hazard caused by impact damage, and is expressed by maximum kinetic energy of a disaster-causing body; H^{d} is a hazard caused by burying and is represented by a maximum burying depth of the disaster-causing body; N_{i,j} is equal to the number of particles in a control grid centered on (i,j) and ΔV is the volume of the particle; A is a grid area; and u and v are speeds in the x direction and the y direction respectively, h is the fluid depth, and ρ is the density of the solid-liquid mixture.

### (2) Vulnerability Analysis

The vulnerability analysis of disaster-bearing bodies is mainly used for computing vulnerability of disaster-bearing bodies. In general, the vulnerability of the disaster-bearing bodies is related to values of the disaster-bearing bodies and vulnerability indexes of the disaster-bearing bodies. Vulnerability of the i^{th} type of disaster-bearing bodies may be described as:

Vᵢ=V(u)ᵢ×Cᵢ

where Vᵢ is vulnerability of the i^{th} type of disaster-bearing bodies, V(u)ₜ is a comprehensive value of the i^{th} type of disaster-bearing bodies, and Cᵢ vulnerability indexes of the i^{th} type of disaster-bearing bodies.

The quantification of the comprehensive value V(u) of the disaster-bearing bodies depends on an average unit price Dₑ of the disaster-bearing bodies and an actual area Aₑ affected by the disaster, and may be expressed as:

V(u)=Dₑ×Aₑ

A value of the vulnerability index C of the disaster-bearing bodies is determined complexly due to the influence of multiple uncertainty factors. Different disaster-bearing bodies are different in positions and damage degrees relative to the debris flow; and the damage degrees of different disaster-bearing bodies are also different when the disaster-bearing bodies are impacted or buried by the same-scale debris flow. The vulnerability index of the disaster-bearing bodies is expressed by a ratio of the fluid depth h to the geometric height H^{c} of the disaster-bearing body and is expressed as:

$$C = \frac{h}{{H}_{c}}$$

where h is a fluid depth, and H_{c} is a geometric height of the disaster-bearing body, such as the height of a bridge deck, a house, etc. When

$$\frac{h}{{H}_{c}} \geq 1 ,$$

it is indicated that the disaster-bearing bodies have been completely buried by the debris flow, and the C is valued as 1.

### (3) Risk Assessment and Grading

Disaster risk evaluation is a comprehensive analysis process about hazard of disaster occurrence and possible harm influence of disaster occurrence, and the risk degree is quantitative expression of the disaster risk. When the disaster occurs, whether the disaster-bearing bodies are exposed to the disaster-causing range of the disaster has uncertainty. On the basis of a numerical simulation result, the risk of the disaster is determined as a comprehensive function of a comprehensive hazard of the disaster, vulnerability of a disaster-bearing body and exposure of the disaster-bearing body, the disaster risk degree is the product of the hazard degree, the vulnerability degree and the exposure degree, a computation equation which is as follows:

$$R = f ( H , {V}_{d} , {E}_{d} ) = {\sum }_{i = 1}^{n} {H}_{i} \times {V}_{i} \times {E}_{i}$$

where R is the risk degree of the disaster and is expressed by a certain numerical value ranging from 0 (no risk) to 1 (high risk); H is the comprehensive disaster-causing risk degree of the disaster, V_{d} is the vulnerability degree of the disaster-bearing body, E_{d} is the exposure degree of the disaster-bearing body, and Hᵢ is the comprehensive disaster-causing risk degree of the i^{th} type of disasters, and is expressed by a certain numerical value ranging from 0 (no hazard) to 1 (high hazard); Vᵢ is vulnerability of the i^{th} type of disaster-bearing bodies and is determined by the damage degree and value or number of the disaster-bearing body; and Eᵢ is the exposure degree of the i^{th} type of disaster-bearing bodies and is expressed by a certain numerical value ranging from 0 (no exposure) to 1 (complete exposure).

The above-mentioned embodiments are merely intended for describing the technical solutions of the present invention rather than limiting the present invention. Although the present invention is described in detail with reference to the above-mentioned embodiments, those of ordinary skill in the art should understand that they may still make modifications to the technical solutions described in the embodiments or equivalent substitutions to some or all of the technical features of the technical solutions. These modifications or substitutions do not enable the corresponding technical solutions to depart from the scope of the technical solutions in the embodiments of the present invention, and should all fall with the scope of the claims and the description of the present invention.

1. A method for a whole-process numerical simulation and a hazard forecast of a mountain disaster, comprising:
S1, a high space-time rainfall forecast of a mountain area: interpolating forecast data having a space resolution of 9 KM to 0.01°*0.01° by means of a bilinear interpolation method, and establishing an empirical relation between a physical quantity and an elevation according to terrains to describe an influence of the terrains on a precipitation;
S2, a hydrodynamic process and numerical simulation: establishing a hydrodynamic process model and solving the hydrodynamic process model;
S3: a motion model and numerical simulation of a mountain torrent and debris flow disaster, wherein a depth-averaged continuous medium equation for a facies averaging rainfall-induced debris flow is expressed as:
$$\frac{\partial h}{\partial t} + \frac{\partial hu}{\partial x} + \frac{\partial hv}{\partial y} = R - I + \frac{E}{1 - p}$$
$$\frac{\partial hu}{\partial x} + \frac{\partial ( {hu}^{2} + 0.5 {gh}^{2} )}{\partial x} + \frac{\partial huv}{\partial y} = - gh \frac{\partial {z}_{b}}{\partial x} - \frac{{τ}_{fx}}{ρ} - \frac{( {ρ}_{s} - {ρ}_{f} ) {gh}^{2}}{2 ρ} \frac{\partial c}{\partial x} + \frac{( {ρ}_{b} - ρ ) uE}{ρ ( 1 - p )}$$
$$\frac{\partial hv}{\partial t} + \frac{\partial huv}{\partial x} + \frac{\partial ( {hv}^{2} + 0.5 {gh}^{2} )}{\partial y} = - gh \frac{\partial {z}_{b}}{\partial y} - \frac{{τ}_{fy}}{ρ} - \frac{( {ρ}_{x} - {ρ}_{f} ) {gh}^{2}}{2 ρ} \frac{\partial c}{\partial y} + \frac{( {ρ}_{b} - ρ ) vE}{ρ ( 1 - p )}$$
$$\frac{\partial hc}{\partial t} + \frac{\partial huc}{\partial x} + \frac{\partial hvc}{\partial y} = E$$
$$\frac{\partial {z}_{b}}{\partial t} = - \frac{E}{1 - p}$$
wherein t represents time, x and y are horizontal coordinates, h represents a fluid depth, u and v are components of a fluid depth-averaged speed in an x direction and a y direction, respectively, c is a depth-averaged solid phase concentration, g is gravitational acceleration, R is a reduced rainfall intensity after vegetation interception, I is an infiltration rate, Z_{b} is a substrate elevation, ρ is a density of a solid-liquid mixture, ρ=cρₛ+(1−c)ρ_{f}, ρₛ and ρ_{f} are concentrations of a solid phase and a liquid phase respectively, ρ_{b} is a density of a saturated substrate, ρ_{b}=(1−d)ρₛ+pρ_{f}, p is the porosity of a substrate material, τ_{fx} and τ_{fy} are substrate resistances in the x direction and the y direction respectively, and E is an erosion rate of the substrate; and
S4, a risk analysis and hazard forecast of a small watershed disaster, further comprising:
computing a comprehensive disaster-causing risk degree of a disaster: determining the comprehensive disaster-causing risk degree of the disaster according to composite hazard characteristics of impact and burying of the mountain disaster;
analyzing a vulnerability: computing a vulnerability of disaster-bearing bodies according to values of the disaster-bearing bodies and vulnerability indexes of the disaster-bearing bodies; and
computing a risk degree of the disaster: determining the risk of the disaster on the basis of a numerical simulation result, wherein the risk of the disaster is a comprehensive function of a comprehensive hazard of the disaster, the vulnerability of the disaster-bearing bodies and exposure of the disaster-bearing bodies;
and a governing equation for the hydrodynamic process model is:
$$\frac{\partial h}{\partial t} + \frac{\partial hu}{\partial x} + \frac{\partial hv}{\partial y} = R - V - I$$
$$\frac{\partial ( 1 / 2 {gh}^{2} )}{\partial x} = - gh \frac{\partial {z}_{b}}{\partial x} + {S}_{fx}$$
$$\frac{\partial ( 1 / 2 {gh}^{2} )}{\partial y} = - gh \frac{\partial {z}_{b}}{\partial y} + {S}_{fy}$$
wherein t is time, x and y are the horizontal coordinates, h represents the fluid depth, u and v represent the speed components of the fluid depth-averaged speed in the x direction and the y direction, respectively, R is the reduced rainfall intensity after the vegetation interception, I is the infiltration rate, V is the vegetation interception, g is the gravitational acceleration, Z_{b} is the substrate elevation, S_{fx} and S_{fy} represent substrate friction terms in the x direction and the y direction, respectively, and
S_{fx} and S_{fy} are expressed by Manning models as:
$${S}_{fx} = g \frac{{n}^{2} u \sqrt{{u}^{2} + {v}^{2}}}{{h}^{1 / 3}}$$
$${S}_{fy} = g \frac{{n}^{2} v \sqrt{{u}^{2} + {v}^{2}}}{{h}^{1 / 3}}$$
wherein n is a Manning coefficient, h represents the fluid depth, u and v represent the speed components of the fluid depth-averaged speed in the x direction and the y direction, respectively, and g is the gravitational acceleration;
an Aston vegetation rainfall interception model used by the vegetation interception V is expressed as:
$$V = {S}_{max} ( 1 - {e}^{- k \frac{{P}_{c}}{{S}_{max}}} )$$
wherein Sₘₐₓ is maximum interception of vegetation, and according to computation of different types of vegetation, P_{c} is accumulated rainfall, and k is a parameter related to a canopy density of the vegetation, and is expressed as:
k=1−e^{-(Co*LAI)},
wherein Co is the canopy density of the vegetation, and LAI is a leaf area index; and
the infiltration rate I is expressed by a slope saturation infiltration model as:
$$I = \frac{df}{dt} = {k}_{s} [ ( {ψ}_{f} + h ) \frac{{θ}_{s} - {θ}_{i}}{f} + 1 ]$$
wherein kₛ is a saturated hydraulic coefficient, ψ_{f} is a matrix suction water head at a front end of a wetting front, θₛ is saturated moisture content of soil, θᵢ is initial moisture content of the soil, and f is an accumulated infiltration depth.

2. The method according to claim 1, wherein in step S1, the bilinear interpolation method comprises:
computing an attribute value at a point P₁=(x, y), carrying out linear interpolation in the x direction to obtain
$$f ( {R}_{1} ) \approx \frac{{x}_{2} - x}{{x}_{2} - {x}_{1}} f ( {Q}_{11} ) + \frac{x - {x}_{1}}{{x}_{2} - {x}_{1}} f ( {Q}_{21} ) , wherein$$
$${R}_{1} = ( x , {1}_{} ) , and$$
$$f ( {R}_{2} ) \approx \frac{{x}_{2} - x}{{x}_{2} - {x}_{1}} f ( {Q}_{12} ) + \frac{x - {x}_{1}}{{x}_{2} - {x}_{1}} f ( {Q}_{22} ) , wherein$$
$${R}_{2} = ( x , {2}_{} ) ,$$
and
then carrying out linear interpolation in the y direction to obtain
$$f ( {P}_{1} ) \approx \frac{{2}_{} -}{{2}_{} - {1}_{}} f ( {R}_{1} ) + \frac{- {1}_{}}{{2}_{} - {1}_{}} f ( {R}_{2} )$$
and to further obtain a desired result f(x, y):
$$f ( x , ) \approx \frac{f ( {Q}_{11} )}{( {x}_{2} - {x}_{1} ) ( {2}_{} - {1}_{} )} ( {x}_{2} - x ) ( {2}_{} - ) + \frac{f ( {Q}_{21} )}{( {x}_{2} - {x}_{1} ) ( {2}_{} - {1}_{} )} ( x - {x}_{1} ) ( {2}_{} - ) + \frac{f ( {Q}_{12} )}{( {x}_{2} - {x}_{1} ) ( {2}_{} - {1}_{} )} ( {x}_{2} - x ) ( - {1}_{} ) + \frac{f ( {Q}_{22} )}{( {x}_{2} - {x}_{1} ) ( {2}_{} - {1}_{} )} ( x - {x}_{1} ) ( - {1}_{} )$$
wherein f represents a corresponding attribute value at a certain point, and Q₁₁, Q₁₂, Q₂₁ and Q₂₂ represent point positions at (x₁, y₁), (x₁, y₂), (x₂, y₁) and (x₂, y₂).

3. The method according to claim 1, wherein in step S2, the establishing of the hydrodynamic process model comprises:
carrying out a deep integral simplification on the basis of a Navier-Stokes equation and ignoring convection terms in a momentum equation to obtain a diffusion wave model, quantitatively computing a hydrodynamic process of a small watershed, introducing the Aston vegetation rainfall interception model and a Green-Ampt slope saturation infiltration model on the basis of the diffusion wave model to establish the hydrodynamic process model, and simulating a whole physical event from rainfall to vegetation interception and slope infiltration and then to runoff generation and motion.

4. The method according to claim 1, wherein in step S2, the solving of the hydrodynamic process model comprises:
carrying out a numerical solution by means of a first-order windward difference scheme to carry out fine-grained parallelization on a program.

5. The method according to claim 1, wherein in step S4, the comprehensive disaster-causing risk degree of the disaster is computed by the following model:
$$H = {H}_{e} + {H}_{d} ,$$
$${H}_{d} = \frac{{N}_{i , j} Δ V}{A}$$
$${H}_{e} = A \cdot {max}_{t > 0} [ ( {u}^{2} + {v}^{2} ) h ρ ]$$
wherein H is the comprehensive disaster-causing risk degree of the disaster, and Hₑ is a hazard caused by impact damage and is expressed by maximum kinetic energy of a disaster-causing body; H_{d} is a hazard caused by burying and is expressed by a maximum burying depth of the disaster-causing body; N_{i, j} is equal to the number of particles in a control grid centered on a point (i, j); ΔV is a volume of the particle; A is a grid area; and u and v represent the speed components of the fluid depth-averaged speed in the x direction and the y direction, respectively, h is the fluid depth, and p is the density of the solid-liquid mixture.

6. The method according to claim 1, wherein in step S4, the computing of the vulnerability of the disaster-bearing bodies according to the values of the disaster-bearing bodies and the vulnerability indexes of the disaster-bearing bodies comprises:
describing vulnerability of the i^{th} type of disaster-bearing bodies as:
Vᵢ=V(u)ᵢ×Cᵢ,
wherein Vᵢ is the vulnerability of the i^{th} type of disaster-bearing bodies, V(u)ᵢ is a comprehensive value of the i^{th} type of disaster-bearing bodies, and Cᵢ is a vulnerability index of the i^{th} type of disaster-bearing bodies,
wherein quantification of the comprehensive value V(u) of the disaster-bearing bodies depends on an average unit price Dₑ of the disaster-bearing bodies and an actual area Aₑ affected by the disaster, which is expressed as:
V(u)=Dₑ*Aₑ, and
the vulnerability index C of the disaster-bearing bodies is expressed as:
$$C = \frac{h}{{H}_{c}}$$
wherein h is the fluid depth, H_{c} is a geometric height of the disaster-bearing bodies, and C is valued as 1 when
$$\frac{h}{{H}_{c}} \geq 1.$$

7. The method according to claim 1, wherein in step S4, the risk degree of the disaster is computed according to the following equation:
$$Ra = f ( H , V , E ) = {\sum }_{i = 1}^{n} {H}_{i} \times {V}_{i} \times {E}_{i}$$
wherein Ra is the risk degree of the disaster and is expressed by a certain numerical value ranging from 0 to 1; Hᵢ is a comprehensive disaster-causing risk degree of the i^{th} type of disasters and is expressed by a certain numerical value ranging from 0 to 1; Vᵢ is a vulnerability degree of the i^{th} type of disaster-bearing bodies and is determined by damage degrees and values or the number of the disaster-bearing bodies; and Eᵢ is an exposure degree of the i^{th} type of disaster-bearing bodies, and is expressed by one of numerical values ranging from 0 to 1.
